(19) United States
(12) Patent Application Publication
(10) Pub. No.: US 2014/0282781 A1
(43) Pub. Date: Sep. 18, 2014

(54) METHODS FOR PROCESSING AND FOR END USER MANAGEMENT OF INTERACTIVE CONTENT AND DEVICES THEREOF

(71) Applicant: WIPRO LIMITED, Bangalore (IN)

(72) Inventors: Francis Antony, Aluva (IN); Prasanth Padmalayam Thankappan, Aluva (IN); Prasanna Prabhu Padmanabha, Aluva (IN)

(73) Assignee: Wipro Limited, Bangalore (IN)

(21) Appl. No.: 13/889,211

(22) Filed: May 7, 2013

(30) Foreign Application Priority Data
Mar. 14, 2013 (IN) 1073/CHE/2013

(51) Int. Cl. H04N 21/435; H04N 21/433; H04N 21/478

(52) U.S. Cl. CPC H04N 21/435; H04N 21/478; H04N 21/433
USPC 725/110

(57) ABSTRACT

A method, non-transitory computer readable medium and device that manage interactive content include initiating at least one widget application. A list of available interactive content previously received and stored from a broadcast stream is received based on the initiated widget application. An item of interactive content is selected from the received list of available interactive content. The selected item of interactive content is received and provided. Another method, non-transitory computer readable medium and device that processes interactive content includes obtaining interactive content from one or more content providers. One of one or more content types for the obtained interactive content is identified and metadata associated with the identified content type is identified. The obtained interactive content is transformed into a standard format based on the identified content type and the metadata associated with the obtained interactive content. The transformed interactive content is transmitted with a broadcast stream.

This application claims the benefit of Indian Patent Application Filing No. 1073/CHE/2013, filed Mar. 14, 2013, which is hereby incorporated by reference in its entirety.

### FIELD

This invention generally relates to interactive content methods and devices and, more particularly, to methods for processing interactive content and for end user management of interactive content and devices thereof.

### BACKGROUND

In a typical digital broadcast television (TV) scenario, a service provider may be mixing multiple types of content, such as video, audio, and interactive-data, and broadcasting it to users. Each of the types of content which are being mixed and provided dynamically may change over time. For example, the service provider may stop sending some types of content, modify the existing content, and/or completely replace the content with a new content. In each of these scenarios, the end user may be losing content which the user may later have an interest in accessing.

Unfortunately, currently end users are not able to classify, manage, and later access interactive content based on their preference. Instead with existing solutions at most end users can simply record all interactive content as part of a digital video recording (DVR) system integrated with receiver stack. However, these DVR systems do not allow a user to categorize and store interactive content based on user preference. Other current existing solutions allow caching/storing of a portion of provided interactive content, but the portion which is cached or stored is controlled by the broadcaster rather than end user. Additionally, the storage life of this content is solely decided by the broadcaster.

### SUMMARY

A method for managing interactive content includes initiating by an interactive receiver device at least one of one or more widget applications. A list of available interactive content previously received and stored from a broadcast stream by the interactive receiver device is received by the interactive receiver device based on the initiated one of the widget applications. An item of interactive content is selected by the interactive receiver device from the received list of available interactive content. The selected item of interactive content is received and provided by the interactive receiver device.

A non-transitory computer readable medium having stored thereon instructions for managing interactive content comprising machine executable code which when executed by a processor, causes the processor to perform steps including initiating at least one of one or more widget applications. A list of available interactive content previously received and stored from a broadcast stream is received based on the initiated one of the widget applications. An item of interactive content is selected from the received list of available interactive content. The selected item of interactive content is received and provided.

An interactive receiver device includes at least one of configurable hardware logic configured to implement or a processor configured to execute programmed instructions stored in a memory including initiating at least one of one or more widget applications. A list of available interactive content previously received and stored from a broadcast stream is received based on the initiated one of the widget applications. An item of interactive content is selected from the received list of available interactive content. The selected item of interactive content is received and provided.

A method for processing interactive content includes obtaining by a broadcaster server interactive content from one or more content providers. One of one or more content types for the obtained interactive content is identified and metadata associated with the identified one of one or more content types is identified by the broadcaster server. The obtained interactive content is transformed by the broadcaster server into a standard format based on the identified one of one or more content types and the metadata associated with the obtained interactive content. The transformed interactive content is transmitted by the broadcast server with a broadcast stream.

A non-transitory computer readable medium having stored thereon instructions for processing interactive content comprising machine executable code which when executed by a processor, causes the processor to perform steps includes obtaining interactive content from one or more content providers. One of one or more content types for the obtained interactive content is identified and metadata associated with the identified one of one or more content types is identified. The obtained interactive content is transformed into a standard format based on the identified one of one or more content types and the metadata associated with the obtained interactive content. The transformed interactive content is transmitted with a broadcast stream.

A broadcast server device includes at least one of configurable hardware logic configured to implement or a processor configured to execute programmed instructions stored in a memory includes obtaining interactive content from one or more content providers. One of one or more content types for the obtained interactive content is identified and metadata associated with the identified one of one or more content types is identified. The obtained interactive content is transformed into a standard format based on the identified one of one or more content types and the metadata associated with the obtained interactive content. The transformed interactive content is transmitted with a broadcast stream.

This technology provides a number of advantages including providing methods, non-transitory computer readable media, and devices that enable effective processing of interactive content and end user management of interactive content. With this technology, interactive content can be selectively stored based on user preferences and presented by a receiver in a television network. Additionally, this technology allows for simultaneous presentation of stored interactive content with a presentation from the broadcast stream. For example, the stored interactive content can be displayed using a widget application while watching a live TV broadcast. Additionally, this technology allows an end user to set a time period for how long different types of interactive content are stored. For example, an end user may set an infinite duration for interactive content comprising recipe information, while setting a two day time period for interactive content comprising weather or news. Further, this technology enables an end user to build and customize a hierarchal list or catalog to further classify the different types of categories of interactive content which is stored. This technology also enables an end user to push stored interactive content to other connected devices.

### BRIEF DESCRIPTION OF THE DRAWINGS

FIG. 1 is a block diagram of an environment with an exemplary broadcast server and an exemplary interactive receiver;

FIG. 2A is a block diagram of an exemplary memory of the exemplary broadcast server;

FIG. 2B is a block diagram of an exemplary memory of the exemplary interactive receiver;

FIG. 3 is a flow chart of an exemplary method for obtaining and installing one or more widget applications;

FIG. 4 is a flow chart of an exemplary method for storing interactive content;

FIG. 5 is a flow chart of an exemplary method for retrieving and presenting interactive content; and

FIG. 6 is a flow chart of an exemplary method for processing interactive content.

### DETAILED DESCRIPTION

An environment 10 with an exemplary broadcast server device 12 and an exemplary interactive receiver device 14 is illustrated in FIGS. 1-2B. In this example, the environment includes the broadcast server 12, the interactive receiver device 14, the content metadata server device 16, an optional user computing device 17, the TV service provider device 18, the service information provider device 20, and the interactive content provider device 22 which are coupled together by communication networks 18(1)-18(3), although the environment can include other numbers and types of systems, devices, components, and/or elements in other configurations and environments and with other communication network topologies. This technology provides a number of advantages including providing methods, non-transitory computer readable media, and devices that enable effective processing of interactive content and end user management of interactive content.

Referring more specifically to FIG. 1, the broadcast server 12 includes at least one central processing unit (CPU) 24, a memory 26, optional configurable hardware logic 23, a network interface 28, and broadcast components 30 which may be coupled together by a bus 32 or other link, although other numbers and types of components, parts, devices, systems, and elements in other configurations and locations can be used.

The central processing unit 24 in the broadcast server device 12 executes a program of stored instructions for one or more aspects of the present invention as described and illustrated by way of the embodiments herein, although the central processing unit 24 could execute other numbers and types of programmed instructions. The memory 26 in the broadcast server device 12 stores these programmed instructions for one or more aspects of the present invention as described and illustrated herein, although some or all of the programmed instructions could be stored and/or executed elsewhere. A variety of different types of memory storage devices, such as a random access memory (RAM) or a read only memory (ROM) in the system or a floppy disk, hard disk, CD ROM, DVD ROM, or other computer readable medium which is read from and/or written to by a magnetic, optical, or other reading and/or writing system that is coupled to the central processing unit 24, can be used for the memory 26.

Referring to FIGS. 1 and 2A, in this example the memory 26 also includes an interactive content enhancer module 40, although the memory 26 can include other types and numbers of applications, programs, modules and other programmed instructions. The interactive content enhancer module 40 includes programmed instructions to transform incoming content from an interactive content provider device into a standard structured interactive content based on the interactive content type and metadata associated with the identified content type, although this module can have other types and numbers of functions and these instructions can be executed in other manners. More specifically, in this example the interactive content enhancer module 40 includes programmed instructions to parse the incoming content to understand the structure of the incoming content and then transforms the incoming content into a standard form. This interactive content enhancer module 40 also includes programmed instructions to enable an authorized person to create, modify, and/or delete metadata for each type of interactive content.

The optional configurable hardware logic 23 in the broadcast server device 12 may comprise specialized hardware configured to be capable of implementing one or more steps of this technology as illustrated and described with reference to the examples herein. By way of example only, the optional configurable logic 23 may comprise one or more of field programmable gate arrays (FPGAs), field programmable logic devices (FPLDs), application specific integrated circuits (ASICs) and/or programmable logic units (PLUs).

The network interface 28 in the broadcast server device 12 is used to operatively couple and communicate between the broadcast server device 12 and the interactive receiver device 14, the content metadata server device 16, the optional user computing device 17, the TV service provider device 18, the service information provider device 20, and the interactive content provider device 22 via one or more of the communication networks 18(1)-18(3), although other types and numbers of communication networks 18(1)-18(3) with other types and numbers of connections and configurations can be used. Additionally, one or more of the communication networks 18(1)-18(3) can include one or more local area networks (LANs) and/or wide area networks (WANs) and also broadcast communications. By way of example only, the broadband communication networks can use TCP/IP over Ethernet and industry-standard protocols, including hypertext transfer protocol (HTTP) and/or secure HTTP (HTTPS), for example, although other types and numbers of communication networks can also be used. Additionally, in this particular example, communication network 18(2) is a broadcast communication network for transmission of television and other broadcast media.

The broadcast components 30 in the broadcast server device 12 include drivers, encoders, multiplexers, and modulators, although the broadcast components can include other types and numbers of systems, devices, components, and/or other elements in other configurations. Since the types and numbers of components of a broadcasting apparatus as well as their interconnections and operations, including obtaining, generating and broadcasting television signals, are well known to those of ordinary skill in the art, thus they will not be described here. By way of example only, an illustrative example of a broadcasting system is disclosed in U.S. Pat. No. 6,353,930 to Shimoji et al. for a, “Digital Broadcasting System, Digital Broadcasting Apparatus, and Receiver Apparatus for Digital Broadcasts” which is herein incorporated by reference in its entirety.

The interactive receiver device 14 includes at least one central processing unit (CPU) 34, a memory 36, optional configurable hardware logic 37, input device 35, display device 38, and a network interface 33 which are coupled together by a bus 39 or other link, although other numbers and types of components, parts, devices, systems, and elements in other configurations and locations can be used.

The central processing unit 34 in the interactive receiver device 14 executes a program of stored instructions for one or more aspects of the present invention as described and illustrated by way of the embodiments herein, although the central processing unit 34 could execute other numbers and types of programmed instructions. The memory 36 in the interactive receiver device 14 stores these programmed instructions for one or more aspects of the present invention as described and illustrated herein, although some or all of the programmed instructions could be stored and/or executed elsewhere. A variety of different types of memory storage devices, such as a random access memory (RAM) or a read only memory (ROM) in the system or a floppy disk, hard disk, CD ROM, DVD ROM, or other computer readable medium which is read from and/or written to by a magnetic, optical, or other reading and/or writing system that is coupled to the central processing unit 34, can be used for the memory 36.

Referring to FIGS. 1 and 2B, in this example the memory 36 in the interactive receiver device 14 includes a data store 78 with the interactive content downloaded based on registered or otherwise recorded preference for a type of content associated with a widget application or based on a selection. The memory 36 in the interactive receiver device 14 also includes a home application 60, an application framework 62, a presentation module 64, a television application 66, digital television middleware 68, interactive middleware 70, digital storage media command and control (DSM-CC) 72, downloaded widget applications 74, an interactive content management module 76, and a data store 78, although the memory can include other types and numbers of applications, programs, modules and other programmed instructions.

The home application 60 in the interactive receiver device 14 is configured to launch when the operating system boots up and includes programmed instructions to display a list of all available applications in the interactive receiver device 14, although this application can have other types and numbers of functions and these instructions can be executed in other manners.

The application framework module 62 in the interactive receiver device 14 includes programmed instructions to manage a lifecycle of all applications in the interactive receiver device 14, although this module can have other types and numbers of functions and these instructions can be executed in other manners.

The presentation module 64 in the interactive receiver device 14 includes programmed instructions to manage the presentation of content on the display device 38 in the interactive receiver device 14, although this module can have other types and numbers of functions and these instructions can be executed in other manners.

The television application 66 in the interactive receiver device 14 includes programmed instructions to manage television broadcast and related features including interactive content, although this application can have other types and numbers of functions and these instructions can be executed in other manners. More specifically, in this example the television application 66 includes programmed instructions to manage the display of video and also information, such as electronic program guides, channel banner, and program information by way of example only, and to manage any user received requests for interactions related to features of the broadcast. Additionally, the television application 66 includes programmed instructions to control the interactive middleware 70 which presents interactive content received from the broadcast stream in the interactive receiver device 14.

The digital television middleware module 68 includes programmed instructions to collect and store table information transmitted inside the transport stream packets by the broadcast server device 12, although this module can have other types and numbers of functions and these instructions can be executed in other manners. This table information is used by the television application 66 for building an electronic programming guide (EPG) and channel banner and for controlling presentation of a television broadcast, such as the audio, video, and subtitles by way of example only, by the presentation module 64.

The interactive middleware module 70 includes programmed instructions to communicate and interact with the digital TV middleware module 68 and the digital storage media command and control (DSM-CC) module 72 to obtain interactive content from a received broadcast stream and present through the display device 38, although this module can have other types and numbers of functions and these instructions can be executed in other manners. The interactive middleware module 70 also includes programmed instructions to pass the obtained interactive content to the interactive content management module 76 for processing.

The digital storage media command and control module (DSM-CC) 72 includes programmed instructions to obtain the interactive content and associated metadata from the broadcast stream, although this module can have other types and numbers of functions and these instructions can be executed in other manners.

Each of the downloaded widget applications 74 in this example is associated with one or more types of interactive content. Additionally, in this example each of the widget applications 74 includes programmed instructions to provide a list or catalog of stored interactive content, related metadata and any stored default or additional annotations, obtain a selection of stored interactive content, related metadata, and/or any stored default or additional annotations. Further, each of the widget applications 74 in this example includes programmed instructions to present the selected stored interactive content, related metadata, and/or any stored default or additional annotations in response to the selection with the input device 35 and through execution of the presentation module 64, although these widget applications can have other types and numbers of functions which interact with other modules, applications or programmed instructions and these instructions can be executed in other manners.

The interactive content management module 76 includes programmed instructions to manage a complete lifecycle of obtained interactive content, although this module can have other types and numbers of functions and these instructions can be executed in other manners. More specifically, the interactive content management module 76 includes programmed instructions to determine which received interactive content to store based on the type of interactive content which is received and registered preferences for one or more particular types of interactive content, although other manners for determining what type of content to store can be used, such as storing based on user selection with input device 35 of the received interactive content and of one or more of the widget applications to be associated with the selection. Additionally, in this example requests to the broadcast server 12 for new types of widget applications can be generated by the interactive receiver device 14. Accordingly, with this technology, the interactive receiver device 14 can receive inputs to register new types of interactive content to store. Further in this example the interactive content management module 76 includes programmed instructions to create and maintain a list or catalog of the interactive content which is stored. With this technology, the interactive receiver device 14 also may customize the manner in which the lists or catalogs are created. For example, the list or catalog for interactive content comprising recipes might be a hierarchical list having a first level on the list comprising: breakfast recipes, lunch recipes and dinner recipes and then under breakfast recipes there may be a second level on the list comprising: breakfast baked good recipes; breakfast egg recipes; and breakfast drink recipes, although other types of lists and catalogs arranged in other manners can be used. Even further in this example the interactive content management module 76 may include programmed instructions and stored data on how long to keep different types of content and when to remove the stored content. For example, stored interactive content on sporting news might be deleted from storage once a week, while interactive content relating to recipes might have an infinite storage life, although other manners for determining and managing a life span of stored interactive content can be used.

The data store 78 includes the interactive content downloaded based on registered or otherwise recorded preference for a type of content associated with a widget application or based on a user selection, although this data store can store other types and amounts of data.

The optional configurable hardware logic 37 in the interactive receiver device 14 may comprise specialized hardware configured to be capable of implementing one or more steps of this technology as illustrated and described with reference to the examples herein. By way of example only, the optional configurable logic 37 may comprise one or more of field programmable gate arrays (FPGAs), field programmable logic devices (FPLDs), application specific integrated circuits (ASICs) and/or programmable logic units (PLUs).

The input device 35 in the interactive receiver device 14 can be used to input selections, such as requesting a widget application for downloading or requesting and selecting from a list of available interactive content, although the input device could be used to input other types of requests, data and/or other inputs and to display other types of data and other information. The user input device in the interactive receiver device 14 can include keypads or touch screens and a computer mouse, although other types and numbers of user input devices can be used.

The display device 38 in the interactive receiver device 14 is used to display information and other data, such as widget applications, lists of interactive content or selected interactive content by way of example only. In this example, the display device 38 in the interactive receiver device 14 is an LED or LCD television flat screen display, although other types of display devices such as plasma screen or CRTs by way of example only, could be used.

The network interface 33 in the interactive receiver device 14 is used to operatively couple and communicate between the interactive receiver device 14 and the broadcast server device 12, the content metadata server device 16, the user computing device 17, via one or more of the communication networks 18(2) and 18(3), although other types and numbers of communication networks with other types and numbers of connections and configurations can be used.

In this example, the content metadata server device 16, the optional user computing device 17, the TV service provider device 18, the service information provider device 20, and the interactive content provider device 22 each include at least one processor, a memory, and a network interface configured to interact with the broadcast server device 12 via one or more of the communication networks 18(1)-18(3), although each of the content metadata server device 16, the optional user computing device 17, the TV service provider device 18, the service information provider device 20, and the interactive content provider device 22 could have other numbers and types of components, parts, devices, systems, and elements in other configurations and locations. The processor in each of the content metadata server device 16, the optional user computing device 17, the TV service provider device 18, the service information provider device 20, and the interactive content provider device 22 executes a program of instructions stored in the memory of each of the content metadata server device 16, the optional user computing device 17, the TV service provider device 18, the service information provider device 20, and the interactive content provider device 22 for one or more aspects of the present invention as described and illustrated by way of the embodiments herein, although the processors could execute other numbers and types of programmed instructions.

The memory in each of the content metadata server device 16, the optional user computing device 17, the TV service provider device 18, the service information provider device 20, and the interactive content provider device 22 stores these programmed instructions for one or more aspects of the present invention as described and illustrated herein, although some or all of the programmed instructions could be stored and/or executed elsewhere. A variety of different types of memory storage devices, such as a random access memory (RAM) or a read only memory (ROM) in the system or a floppy disk, hard disk, CD ROM, DVD ROM, or other computer readable medium which is read from and/or written to by a magnetic, optical, or other reading and/or writing system that is coupled to the processor, can be used for the memory in each of the content metadata server device 16, the optional user computing device 17, the TV service provider device 18, the service information provider device 20, and the interactive content provider device 22.

The network interface in each of the content metadata server device 16, the optional user computing device 17, the TV service provider device 18, the service information provider device 20, and the interactive content provider device 22 can be used to operatively couple and communicate between each of the content metadata server device 16, the optional user computing device 17, the TV service provider device 18, the service information provider device 20, and the interactive content provider device 22 and the broadcast server device 12 via one or more of the communication networks 18(1)-18(3).

In this example, the memory in the content metadata server device 16 also maintains a repository of metadata associated with types of interactive content along with the widget application associated with the type of content. A widget application along with the type of interactive content and the corresponding metadata is called a widget-package. The interactive content enhancer module 40 in the broadcast server device 12 provides content metadata server device 16 with instructions to add/modify/delete a widget-package. Each of these widget-packages can be downloaded by the interactive receiver device 14 using a back-channel, such as broadband by way of example only. The content metadata server device 16 also maintains a list of available widget packages in a repository in memory.

Although examples of the broadcast server device 12, the interactive receiver device 14, the content metadata server device 16, the optional user computing device 17, the TV service provider device 18, the service information provider device 20, and the interactive content provider device 22, are described and illustrated herein, each of the broadcast server device 12, the interactive receiver device 14, the content metadata server device 16, the optional user computing device 17, the TV service provider device 18, the service information provider device 20, and the interactive content provider device 22 can be implemented on any suitable computer apparatus or computing device. It is to be understood that the apparatuses and devices of the embodiments described herein are for exemplary purposes, as many variations of the specific hardware and software used to implement the embodiments are possible, as will be appreciated by those skilled in the relevant art(s).

Furthermore, each of the devices of the embodiments may be conveniently implemented using one or more general purpose computers, microprocessors, digital signal processors, and micro-controllers, programmed according to the teachings of the embodiments, as described and illustrated herein, and as will be appreciated by those of ordinary skill in the art.

The examples also may be embodied as one or more non-transitory computer readable medium having instructions stored thereon for one or more aspects of the present invention as described and illustrated by way of the embodiments herein, as described herein, which when executed by a processor, cause the processor to carry out the steps necessary to implement the methods of the embodiments, as described and illustrated herein.

An exemplary method for obtaining and installing one or more widget applications will now be described with reference to FIGS. 1-3. In step 100, the interactive receiver device 14 requests and receives a list of the available widget applications 74 from the content metadata server 16 over a broadband connection via communication network 18(3) between the interactive receiver device 14 and the content metadata server 16, although the widget applications 74 could be obtained from other sources in other manners and over other communication paths. Each of the widget applications 74 is associated with one or more types of interactive content. Additionally, each of the widget application include programmed instructions to provide a list or catalog of stored interactive content, related metadata and any stored default or additional annotations, obtain a selection of stored interactive content, related metadata, and/or any stored default or additional annotations. Further, each of the widget applications 74 includes programmed instructions to present the selected stored interactive content, related metadata, and/or any stored default or additional annotations in response to the selection using in the example the input device 35 and execution of the presentation module 64 for display on display device 38, although the widget applications can have other types and numbers of functions and these instructions can be executed in other manners.

In step 102, the interactive receiver device 14 provides a selection of one or more of the available widget applications to the content metadata server 16, although other manners for selecting widget applications for downloading can be used. In response to the selection, the content metadata server 16 provides the selected one or more available widget applications 74 to the interactive receiver device 14 for downloading.

In step 104, the interactive receiver device 14 downloads the selected one or more widget packages with widget applications 74 from the content metadata server 16, although other manners for downloading the widget packages can be used. In this example, the widget packages include widget applications and related metadata, although the widget packages could include other types and numbers of applications and data.

An exemplary method for storing interactive content will now be described with reference to FIGS. 1, 2A, 2B and 4. In step 200, the interactive receiver device 14 receives a broadcast stream which includes interactive content from the broadcast server device 12, although other manners for receiving the broadcast stream can be used.

In step 202, the interactive receiver device 14 determines whether a type of content for the interactive content in the broadcast stream matches a type of content associated with any of the widget applications 74 downloaded by the interactive receiver 14. If in step 202 the interactive receiver device 14 determines the type of content for the interactive content in the broadcast stream does not match a type of content associated with any of the widget applications 74 downloaded by the interactive receiver 14, then the No branch is taken back to step 200 to continue to monitor the broadcast stream. If in step 202 the interactive receiver device 14 determines the type of content for the interactive content in the broadcast stream does match a type of content associated with any of the widget applications 74 downloaded by the interactive receiver 14, then the Yes branch is taken to step 204.

In step 204, the interactive receiver device 14 stores the received interactive content in memory 36 based on the match of the type of interactive content which is received and the registered preferences for one or more particular types of interactive content, although the received interactive content could be stored in other locations, such as the content metadata server device 16 by way of example only. Additionally, the interactive receiver device 14 generates a list of the stored interactive content for each of the downloaded widget applications 74 associated with the stored interactive content, although other manners for cataloging the stored content can be used. With this technology, the interactive receiver device 14 also may customize the manner in which the lists or catalogs are created. The interactive receiver device 14 could analyze the received interactive content and create a hierarchical list or catalog of the stored interactive content for each of the widget applications. For example, the list or catalog for interactive content comprising recipes might be a hierarchical list having a first level on the list comprising: breakfast recipes, lunch recipes and dinner recipes and then under breakfast recipes there may second level on the list comprising: breakfast baked good recipes; breakfast egg recipes; and breakfast drink recipes, although other types of lists and catalogs arranged in other manners can be used.

In step 206, the interactive receiver device 14 may also obtain from memory 36 stored default annotations associated with the type of interactive content which was received and is being stored, although the default annotations can be obtained in other manners. The interactive receiver device 14 stores the obtained default annotations with the stored interactive content.

In step 208, the interactive receiver device 14 also may optionally obtain additional annotations associated with the type of interactive content which was received and is being stored. In this example, the additional annotations are obtained by the interactive receiver device 14 via user input through the input device 35, although other manners for obtaining the additional annotations could be used.

In step 210, the interactive receiver device 14 determines whether a set time period for any of the stored interactive content associated with any of the selected and downloaded widget applications has expired. For example, the interactive receiver device 14 may determine that stored interactive content on sporting news should be deleted from storage once a week, while interactive content relating to recipes might have an infinite storage life, although other manners for determining and managing a life span of stored interactive content can be used. The set time period for each type of interactive content can be set and adjusted by the interactive receiver device 14.

If in step 210 the interactive receiver device 14 determines the set time period for any of the stored interactive content associated with any of the selected and downloaded widget applications has not expired, then the No branch is taken back to step 200 to continue to monitor the broadcast stream. If in step 210 the interactive receiver device 14 determines the set time period for any of the stored interactive content associated with any of the selected and downloaded widget applications has expired, then the Yes branch is taken back to step 212. In step 212, the interactive receiver device 14 deletes the stored interactive content whose set time period has expired from memory 36 or from wherever the stored interactive content was maintained and then returns to step 200.

An exemplary method for retrieving and presenting interactive content will now be described with reference to FIGS. 1, 2A, 2B and 5. In step 300, the interactive receiver device 14 activates the home application 60 and in response to a received request initiates one of the widget applications.

In step 302, the interactive receiver device 14 may determine whether a set time period for any of the stored interactive content associated with any of the selected and downloaded widget applications has expired. For example, the interactive receiver device 14 may determine that stored interactive content on sporting news should be deleted from storage once a week, while interactive content relating to recipes might have an infinite storage life, although other manners for determining and managing a life span of stored interactive content can be used. The set time period for each type of interactive content can be set and adjusted by the interactive receiver device 14.

If in step 302 the interactive receiver device 14 determines the set time period for any of the stored interactive content associated with any of the selected and downloaded widget applications has not expired, then the No branch is taken to step 306. If in step 302 the interactive receiver device 14 determines the set time period for any of the stored interactive content associated with any of the selected and downloaded widget applications has expired, then the Yes branch is taken to step 304. In step 304, the interactive receiver device 14 deletes the stored interactive content whose set time period has expired from memory 36 or from wherever the stored interactive content was maintained and then proceeds to step 306.

In step 306, the interactive receiver device 14 receives a list of available interactive content previously received and stored from the broadcast stream based on the initiated one of the widget applications. The interactive receiver device 14 displays the list of available interactive content on the display device 38, although other manners for presenting the list or other catalog of available interactive content can be used.

In step 308, the interactive receiver device 14 receives via the input device 35 a selection of one of the items of interactive content from the received list of available interactive content, although other manners for receiving a selection of an item of interactive content could be used. By way of example only, the a request for an item of interactive content from the received list of available interactive content could be received from another computing device 17 in communication with the interactive receiver device 14.

In step 310, the interactive receiver device 14 obtains the selected item of interactive content from memory 36 or other location, such as content metadata server device 16 by way of example only, although the selected item of interactive content could be obtained from other locations. Additionally, the interactive receiver device 14 obtains metadata associated with the selected item of interactive content from the content metadata server device 16, although the metadata could be obtained in other manners.

In step 312, the interactive receiver device presents the selected item of interactive content on the display device 38 using the obtained metadata and the presentation module 64, although other manners for presenting the selected item of interactive content could be used. Optionally, the interactive receiver device 14 could present other content simultaneously with the selected item of interactive content, such as with a television program in the broadcast stream. Additionally and by way of example only, the interactive receiver device 14 could obtain and provide the selected item of interactive content to the computing device 17.

An exemplary method for processing interactive content will now be described with reference to FIGS. 1, 2A, 2B and 6. In step 400, the broadcast server device 12 obtains a television signal from a television service provider device 18, service information about the television broadcast from service information provider device 20 and interactive content from interactive content provider device 22, although the television signal, service information and/or interactive content can be obtained from other sources and in other manners.

In step 402, the broadcast server device 12 identifies the type of content obtained from the interactive content provider device 22, although the type of interactive content can be determined in other manners. Additionally, the broadcast server device 12 obtains metadata associated with the type of content from the content metadata server 16 originally provided by the broadcast server 16, although the metadata can be obtained in other manners and from other sources.

In step 404, the broadcast server device 12 may transform the obtained interactive content into a standard format based on the identified type of content and the obtained metadata associated with the obtained interactive content, although the interactive content may be transformed into other formats or may not undergo any transformation.

In step 406, the broadcast server device 12 transmits the transformed interactive content with the broadcast stream to the interactive receiver device 14, although the transformed interactive content and/or broadcast stream can be provided to the interactive receiver device 14 in other manners, such as via a broadband connection by way of example only.

Accordingly, as illustrated and described with reference to the examples herein, this technology provides methods, non-transitory computer readable media, and devices that enable effective processing of interactive content and end user management of interactive content. With this technology, interactive content can be selectively stored based on user preferences and presented by a receiver in a television network. Additionally, this technology allows for simultaneous presentation of stored interactive content with a presentation from the broadcast stream. Additionally, this technology allows an end user to set a time period for how long different types of interactive content are stored. Further, this technology enables an end user to build and customize a hierarchal list or catalog to further classify the different types of categories of interactive content which is stored. This technology also enables an end user to share stored interactive content to other connected devices.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for managing interactive content, the method comprising:
initiating by an interactive receiver device at least one of one or more widget applications;
receiving by the interactive receiver device a list of available interactive content previously received and stored from a broadcast stream by the interactive receiver device based on the initiated one of the widget applications;
selecting by the interactive receiver device an item of interactive content from the received list of available interactive content; and
receiving and providing by the interactive receiver device the selected item of interactive content.

2. The method as set forth in claim 1 further comprising:
obtaining by the interactive receiver device a list of one or more available widget applications;
selecting by the interactive receiver device one or more of the received one or more available widget applications; and
downloading by the interactive receiver device the selected one or more of the available widget applications.

3. The method as set forth in claim 1 further comprising:
receiving by the interactive receiver device the broadcast stream with the interactive content;
determining by the interactive receiver device whether any of the received interactive content in the broadcast stream corresponds with one or more types of interactive content associated with any of the one or more widget applications; and
storing in real time by the interactive receiver device the received interactive content determined to be associated with any of the one or more widget applications.

4. The method as set forth in claim 3 further comprising:
obtaining by the interactive receiver device one or more default annotations for the received interactive content determined to be associated with any of the one or more widget applications; and
storing by the interactive receiver device the obtained one or more default annotations with the received interactive content determined to be associated with any of the one or more widget applications.

5. The method as set forth in claim 4 further comprising:
providing by the interactive receiver device one or more additional annotations for the received interactive content determined to be associated with any of the one or more widget applications; and
storing by the interactive receiver device the provided one or more additional annotations with the received interactive content determined to be associated with any of the one or more widget applications.

6. The method as set forth in claim 3 further comprising;
determining by the interactive receiver device a time limit for the storing of the received interactive content with at least one of the one or more of the selected widget applications based on one or more factors; and
removing by the interactive receiver device the stored interactive content after the determined time limit has expired.

7. The method as set forth in claim 1 further comprising:
receiving by the interactive receiver device the broadcast stream with the interactive content; and
receiving by the interactive receiver device a selection of any of the received interactive content in the broadcast stream and of one or more of the widget applications to be associated with the selection; and
storing in real time by the interactive receiver device the selection of the received interactive content with the associated one or more widget applications.

8. The method as set forth in claim 7 further comprising:
obtaining by the interactive receiver device one or more default annotations for the received interactive content associated with one or more of the widget applications; and
storing by the interactive receiver device the obtained one or more default annotations with the received interactive content associated with one or more of the widget applications.

9. The method as set forth in claim 8 further comprising:
providing by the interactive receiver device one or more additional annotations for the received interactive content associated with one or more of the widget applications; and
storing by the interactive receiver device the provided one or more additional annotations with the received interactive content associated with one or more of the widget applications.

10. The method as set forth in claim 7 further comprising;
determining by the interactive receiver device a time limit for the storing of the selection of the received interactive content with the associated one or more widget applications based on one or more factors; and
removing by the interactive receiver device the stored interactive content after the determined time limit has expired.

11. The method as set forth in claim 1 wherein the receiving and providing further comprises receiving and providing by the interactive receiver device any stored annotations associated with the selected item of interactive content.

12. The method as set forth in claim 1 further comprising generating by the interactive receiver device the list of the available interactive content associated with each of the one or more of the widget applications.

13. The method as set forth in claim 1 wherein the selecting further comprises:
receiving by the interactive receiver device a request for the selected item of interactive content from the received list of available interactive content from another computing device in communication with the interactive receiver device; and
providing by the interactive receiver device the selected item of interactive content to the another computing device.

14. The method as set forth in claim 1 wherein the receiving and providing further comprises:
receiving by the interactive receiver device metadata associated with the selected item of interactive content; and
presenting by the interactive receiver device the selected item of interactive content based on the received metadata.

15. The method as set forth in claim 14 wherein the presenting further comprises presenting by the interactive receiver device other content simultaneously with the presenting the selected item of interactive content based on the received metadata.

16. A non-transitory computer readable medium having stored thereon instructions for managing interactive content comprising machine executable code which when executed by a processor, causes the processor to perform steps comprising:
initiating at least one of one or more widget applications;
receiving a list of available interactive content previously received and stored from a broadcast stream based on the initiated one of the widget applications;
selecting an item of interactive content from the received list of available interactive content; and
receiving and providing the selected item of interactive content.

17. The medium as set forth in claim 16 further comprising:
obtaining a list of one or more available widget applications;
selecting one or more of the received one or more available widget applications; and
downloading the selected one or more of the available widget applications.

18. The medium as set forth in claim 16 further comprising:
receiving the broadcast stream with the interactive content;
determining whether any of the received interactive content in the broadcast stream corresponds with one or more types of interactive content associated with any of the one or more widget applications; and
storing in real time the received interactive content determined to be associated with any of the one or more widget applications.

19. The medium as set forth in claim 18 further comprising:
obtaining one or more default annotations for the received interactive content determined to be associated with any of the one or more widget applications; and
storing the obtained one or more default annotations with the received interactive content determined to be associated with any of the one or more widget applications.

20. The medium as set forth in claim 19 further comprising:
providing one or more additional annotations for the received interactive content determined to be associated with any of the one or more widget applications; and
storing the provided one or more additional annotations with the received interactive content determined to be associated with any of the one or more widget applications.

21. The medium as set forth in claim 18 further comprising;
determining a time limit for the storing of the received interactive content with at least one of the one or more of the selected widget applications based on one or more factors; and
removing the stored interactive content after the determined time limit has expired.

22. The medium as set forth in claim 16 further comprising:
receiving the broadcast stream with the interactive content; and
receiving a selection of any of the received interactive content in the broadcast stream and of one or more of the widget applications to be associated with the selection; and
storing in real time the selection of the received interactive content with the associated one or more widget applications.

23. The medium as set forth in claim 22 further comprising:
obtaining one or more default annotations for the received interactive content associated with one or more of the widget applications; and
storing the obtained one or more default annotations with the received interactive content associated with one or more of the widget applications.

24. The medium as set forth in claim 23 further comprising:
providing one or more additional annotations for the received interactive content associated with one or more of the widget applications; and
storing the provided one or more additional annotations with the received interactive content associated with one or more of the widget applications.

25. The medium as set forth in claim 22 further comprising;
determining a time limit for the storing of the selection of the received interactive content with the associated one or more widget applications based on one or more factors; and
removing the stored interactive content after the determined time limit has expired.

26. The medium as set forth in claim 16 wherein the receiving and providing further comprises receiving and providing any stored annotations associated with the selected item of interactive content.

27. The medium as set forth in claim 16 further comprising generating the list of the available interactive content associated with each of the one or more of the widget applications.

28. The medium as set forth in claim 16 wherein the selecting further comprises:
receiving a request for the selected item of interactive content from the received list of available interactive content from another computing device in communication with the interactive receiver device; and
providing the selected item of interactive content to the another computing device.

29. The medium as set forth in claim 16 wherein the receiving and providing further comprises:
receiving metadata associated with the selected item of interactive content; and
presenting the selected item of interactive content based on the received metadata.

30. The medium as set forth in claim 29 wherein the presenting further comprises presenting other content simultaneously with the presenting the selected item of interactive content based on the received metadata.

31. An interactive receiver device comprising:
at least one of configurable hardware logic configured to implement or a processor configured to execute programmed instructions stored in a memory comprising:
initiating at least one of one or more widget applications;
receiving a list of available interactive content previously received and stored from a broadcast stream based on the initiated one of the widget applications;
selecting an item of interactive content from the received list of available interactive content; and
receiving and providing the selected item of interactive content.

32. The device as set forth in claim 31 wherein the at least one of the configurable hardware logic is further configured to implement or the processor is further configured to execute programmed instructions stored in the memory further comprising:
obtaining a list of one or more available widget applications;
selecting one or more of the received one or more available widget applications; and
downloading the selected one or more of the available widget applications.

33. The device as set forth in claim 31 wherein the at least one of the configurable hardware logic is further configured to implement or the processor is further configured to execute programmed instructions stored in the memory further comprising:
receiving the broadcast stream with the interactive content;
determining whether any of the received interactive content in the broadcast stream corresponds with one or more types of interactive content associated with any of the one or more widget applications; and
storing in real time the received interactive content determined to be associated with any of the one or more widget applications.

34. The device as set forth in claim 33 wherein the at least one of the configurable hardware logic is further configured to implement or the processor is further configured to execute programmed instructions stored in the memory further comprising:
obtaining one or more default annotations for the received interactive content determined to be associated with any of the one or more widget applications; and
storing the obtained one or more default annotations with the received interactive content determined to be associated with any of the one or more widget applications.

35. The device as set forth in claim 34 wherein the at least one of the configurable hardware logic is further configured to implement or the processor is further configured to execute programmed instructions stored in the memory further comprising:
providing one or more additional annotations for the received interactive content determined to be associated with any of the one or more widget applications; and
storing the provided one or more additional annotations with the received interactive content determined to be associated with any of the one or more widget applications.

36. The device as set forth in claim 33 wherein the at least one of the configurable hardware logic is further configured to implement or the processor is further configured to execute programmed instructions stored in the memory further comprising;
determining a time limit for the storing of the received interactive content with at least one of the one or more of the selected widget applications based on one or more factors; and
removing the stored interactive content after the determined time limit has expired.

37. The device as set forth in claim 31 wherein the at least one of the configurable hardware logic is further configured to implement or the processor is further configured to execute programmed instructions stored in the memory further comprising:
receiving the broadcast stream with the interactive content; and
receiving a selection of any of the received interactive content in the broadcast stream and of one or more of the widget applications to be associated with the selection; and
storing in real time the selection of the received interactive content with the associated one or more widget applications.

38. The device as set forth in claim 37 wherein the at least one of the configurable hardware logic is further configured to implement or the processor is further configured to execute programmed instructions stored in the memory further comprising:
obtaining one or more default annotations for the received interactive content associated with one or more of the widget applications; and
storing the obtained one or more default annotations with the received interactive content associated with one or more of the widget applications.

39. The device as set forth in claim 38 wherein the at least one of the configurable hardware logic is further configured to implement or the processor is further configured to execute programmed instructions stored in the memory further comprising:
providing one or more additional annotations for the received interactive content associated with one or more of the widget applications; and
storing the provided one or more additional annotations with the received interactive content associated with one or more of the widget applications.

40. The device as set forth in claim 37 wherein the at least one of the configurable hardware logic is further configured to implement or the processor is further configured to execute programmed instructions stored in the memory further comprising;
determining a time limit for the storing of the selection of the received interactive content with the associated one or more widget applications based on one or more factors; and
removing the stored interactive content after the determined time limit has expired.

41. The device as set forth in claim 31 wherein the at least one of the configurable hardware logic is further configured to implement or the processor is further configured to execute programmed instructions stored in the memory wherein the receiving and providing further comprises receiving and providing any stored annotations associated with the selected item of interactive content.

42. The device as set forth in claim 31 wherein the at least one of the configurable hardware logic is further configured to implement or the processor is further configured to execute programmed instructions stored in the memory further comprising generating the list of the available interactive content associated with each of the one or more of the widget applications.

43. The device as set forth in claim 31 wherein the at least one of the configurable hardware logic is further configured to implement or the processor is further configured to execute programmed instructions stored in the memory wherein the selecting further comprises:
receiving a request for the selected item of interactive content from the received list of available interactive content from another computing device in communication with the interactive receiver device; and
providing the selected item of interactive content to the another computing device.

44. The device as set forth in claim 31 wherein the at least one of the configurable hardware logic is further configured to implement or the processor is further configured to execute programmed instructions stored in the memory wherein the receiving and providing further comprises:
receiving metadata associated with the selected item of interactive content; and
presenting the selected item of interactive content based on the received metadata.

45. The device as set forth in claim 44 wherein the at least one of the configurable hardware logic is further configured to implement or the processor is further configured to execute programmed instructions stored in the memory wherein the presenting further comprises presenting other content simultaneously with the presenting the selected item of interactive content based on the received metadata.

46. A method for processing interactive content, the method comprising:
obtaining by a broadcaster server interactive content from one or more content providers;
identifying by the broadcaster server one of one or more content types for the obtained interactive content and metadata associated with the identified one of one or more content types;
transforming by the broadcaster server the obtained interactive content into a standard format based on the identified one of one or more content types and the metadata associated with the obtained interactive content; and
transmitting by the broadcast server the transformed interactive content with a broadcast stream.

47. The method as set forth in claim 46 further comprising:
obtaining by the broadcaster server metadata associated with the identified one of one or more content types; and
providing by the broadcaster server the obtained metadata associated with the transformed interactive content via a broadband connection.

48. The method as set forth in claim 46 further comprising:
generating by the broadcaster server a widget application for each of the one or more content types; and
providing by the broadcast server the generated widget application for each of the one or more content types.

49. A non-transitory computer readable medium having stored thereon instructions for processing interactive content comprising machine executable code which when executed by a processor, causes the processor to perform steps comprising:
obtaining interactive content from one or more content providers;
identifying one of one or more content types for the obtained interactive content and metadata associated with the identified one of one or more content types;
transforming the obtained interactive content into a standard format based on the identified one of one or more content types and the metadata associated with the obtained interactive content; and
transmitting the transformed interactive content with a broadcast stream.

50. The medium as set forth in claim 49 further comprising:
obtaining metadata associated with the identified one of one or more content types; and
providing the obtained metadata associated with the transformed interactive content via an associated broadband connection.

51. The medium as set forth in claim 49 further comprising:
generating a widget application for each of the one or more content types; and
providing the generated widget application for each of the one or more content types.

52. A broadcast server device comprising:
at least one of configurable hardware logic configured to implement or a processor configured to execute programmed instructions stored in a memory comprising:
obtaining interactive content from one or more content providers;
identifying one of one or more content types for the obtained interactive content and metadata associated with the identified one of one or more content types;
transforming the obtained interactive content into a standard format based on the identified one of one or more content types and the metadata associated with the obtained interactive content; and
transmitting the transformed interactive content with a broadcast stream.

53. The device as set forth in claim 52 wherein the at least one of the configurable hardware logic is further configured to implement or the processor is further configured to execute programmed instructions stored in the memory comprising further comprising:
obtaining metadata associated with the identified one of one or more content types; and
providing the obtained metadata associated with the transformed interactive content via an associated broadband connection.

54. The device as set forth in claim 52 wherein the at least one of configurable hardware logic is further configured to implement or the processor is further configured to execute programmed instructions stored in the memory comprising further comprising:
generating a widget application for each of the one or more content types; and
providing the generated widget application for each of the one or more content types.
